(19) United States
(12) Patent Application Publication
(10) Pub. No.: US 2011/0008021 A1
(43) Pub. Date: Jan. 13, 2011

(54) METHOD FOR RAPID ARCHIVING AND RESTORING OF A VIDEO STORE

(76) Inventor: David Alan Casper, Nevada City, CA (US)

Correspondence Address: Robert D. Shedd, Patent Operations;THOMSON Licensing LLC, P.O. Box 5312, Princeton, NJ, 08543-5312, US

(21) Appl. No.: 12/736,249

(22) PCT Filed: Mar. 26, 2008
(86) PCT No.: PCT/US2008/003944

§ 371 Date: Sep. 22, 2010

(51) Int. Cl. H04N 5/92

(52) U.S. Cl. 386/326; 386/E05.009

(57) ABSTRACT

An apparatus, method and software program product for rapid archiving and restoring of a video store. The method includes receiving and recording video signals representing the video data more than one time responsive to a first command; and terminating the recording of the video signals responsive to a second command. The recoding of the video signals is performed at a video rate. The method further includes receiving video signals from the video recoding device playing back the stored plurality of instances of the video data; recording the received video signals to a memory responsive to a command; and terminating the recording process when the memory is filled, wherein the recorded video signals includes at least one instance of the video.

### FIELD OF THE INVENTION

The present invention generally relates to an enhanced system of video restoring and archiving of a video store at video rates and improvements in synchronization.

### BACKGROUND OF THE INVENTION

The video production and reproduction art suffers from a video speed problem regarding the backup and loading of a video store. A video store is a storage device that stores video clips and/or video stills (fields or frames). Some video stores are comprised of non-volatile memory (e.g., a flash memory) and others have regular static or dynamic random access memory (RAM). A target video store receives one or more video clip(s) where they will be stored while another set of information termed ‘metadata’ is kept in RAM accessible by a central processing unit (CPU). This metadata comprises a variety of information associated with the one or more video clip(s).

Types of metadata include a ‘directory structure’ as well as precise technical information about the video and qualitative descriptions. A ‘directory structure’ typically consists of a directory entry for each clip giving its name (or abbreviated name), its start position and end position in the RAM, and other valuable data about the content. Another form of metadata comprises precise technical information including the duration, image size, line rate, fencing and cropping information, mark-in and mark-out points, creation date as well as other information. Additionally, the qualitative description of the video content includes whether it has been approved for air, content rating, keyword descriptions and many others.

But there exists a great disparity in size between the quantity of video in a clip and the quantity of associated metadata. For example, for one second of high definition video, there needs to be approximately 125 Megabytes of memory to accurately capture the uncompressed video images. In comparison, the directory and/or metadata associated with this approximately one 125 Megabytes video clip would rarely reach ten (10) kilobytes and typically only amounts to a few hundred bytes.

Current techniques for storing video clips and metadata require the loading of video clips into a video store by a file transfer mechanism and the storage of the metadata in a CPU RAM. The video is encoded into a standard file format by a control processor and the file transferred to the target video store typically via Ethernet interfaces. The storage of the video clips is a very slow process because of the quantity of data involved. As a relevant example, a single frame of video can take several seconds to load by file transfer, while it takes only one thirtieth of a second to play this frame in ordinary video play mode. A one (1) minute video clip can easily take an hour or more to load. In certain operational systems this presents no problem since these can be set up to load data intermittently over a period of days. However, not all operating environments are so robustly configured to stretch out the procedure over several days. For example, some video stores use volatile memory that can be highly vulnerable to power losses that can result in the catastrophic loss of all video imagery. Thus, even a momentary power loss can damage the recovery of valuable video data.

Loading a video store from video is in itself not new—but there are difficulties in the prior art approach. The most common means of recording is to set the store into record mode, then playing the source material e.g., from a video tape recorder (VTR), a direct to disk recording (DDR), or a live camera input, then stopping the recording. As a result, in the prior art an excess of video data is recorded and user action is necessary to trim the head and tail of the video clip so that only the desired portion remains in the clip. Thus, the prior art techniques require both an excess capacity to store the unwanted extra data contained in the head and tail of the video clip as well as direct manual user interaction to trim the unwanted material.

It is possible to automate the user's actions through a software control system synchronously starting the source material playing and the store recording, and then simultaneously stopping both devices after a calculated clip duration. However, this approach presents a practical difficulty in that frame accurate synchronization of these devices can only be implemented through a very complex architecture. Also, it must be noted that everything that has been described up to now applies equally to archiving clips, one at a time from the video store to DDR or VTR. As a further complication, the synchronization suffers from the incompatibility of source and target video storage devices when manufactured by different vendors.

Accordingly, there exists a need for overcoming the disadvantages of the prior art synchronization problems as discussed above.

### SUMMARY OF THE INVENTION

An embodiment of the invention provides a method for archiving first video data from a video store. The method includes receiving video signals representing the first video data responsive to a first command; recording a portion of the received video signals; and terminating the recording process responsive to a second command, wherein the recorded video signals represent more than one instance of the first video data.

In another embodiment, the invention provides a method for recording video data comprising: receiving, by a video store, a first command for repeatedly playing back the first video data for a number of times; and playing back, by the video store, the first video data for the number of times, wherein a portion of the played first video data is recorded by a video recording device and the recorded played first video data represents more than one instance of the first video data.

In another embodiment, the invention provides a method for restoring first video data from a video recoding device storing second video data representing more than one instance of the first video data, comprising: receiving video signals from the video recoding device playing back the second video data; recording a portion of the received video signals to a memory responsive to a command; and terminating the recording process when the memory is filled, wherein the recorded video signals represents at least one instance of the first video data.

In yet another embodiment, the invention provides a method for restoring first video data from a video recoding device storing second video data representing more than one instance of the first video data, comprising: transmitting video signals from the video recoding device (120) playing back the second video data (S310), wherein the video signals are received by a video store and a portion of said received video signals is recorded by the video store in a memory; and terminating the playing back process responsive to a signal generated when the memory (102) has been filled and the recorded video signals represent at least one instance of the first video data (S340).

### BRIEF DESCRIPTION OF THE FIGURES

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a Video Storage System that is to be utilized in the present invention.

FIG. 2 illustrates the archival creation process of the Video Storage System of the present invention.

FIG. 3 illustrates the archival restoration process of the Video Storage System of the present invention.

FIG. 4 illustrates the resynchronization step of a video store directory.

### DETAILED DESCRIPTION OF THE PREFERRED EMBODIMENTS

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

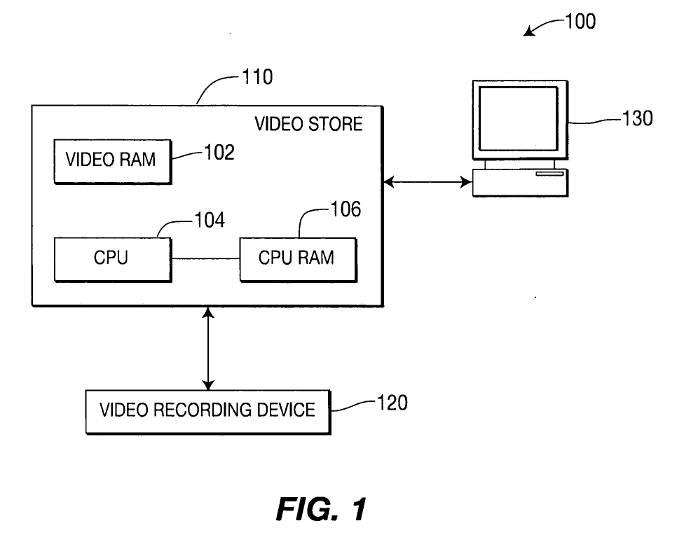

FIG. 1 shows a video storage system 100 used to describe the principles of the invention. The system 100 comprises a video store 110 connected to a video recording device 120, and preferably a computer 130 through which a user can access and control the video store 110. The video recording device 120 may be, but is not limited to, a digital video disc (DVD) recorder, a digital disk recorder (DDR), a video tape recorder (VTR), and the likes. The video recording device 120 may include an internal and/or external memory unit (not shown). The memory unit may be any form of erasable memory including, but not limited to, a volatile memory (e.g., a RAM), a non-volatile memory (e.g., a disk drive or a flash driver), and the likes. The video store 110 and the video recording device 120 may be connected using wired connections, such as cabling or using wireless electromagnetic communication. Composite video cables, component video cables, and S-video cables are examples of cables used in wired connections to connect video outputs of one device to the video inputs of the other.

The video store 110 includes a video RAM 102, a central processing unit (CPU) 104, and a RAM 106 accessed by the CPU 104 (hereinafter “CPU-RAM” 106). The video RAM 102 stores video clips and/or video stills (fields or frames). The CPU-RAM 106 maintains directory and metadata information associated with video clips stored in the video RAM 102. Specifically, the video RAM 102 is loaded with video clips using a file transfer mechanism. This mechanism also builds and saves the associated directory entries and metadata in the CPU-RAM 106. The CPU 104 executes at least the processes related to video store archival creation and restoration. With this aim, the CPU 104 controls the video recording device 120 and may also receive commands from the computer 130 if the archiving and/or restoring processes are performed manually (i.e., by control of a user).

The invention describes the archiving and restoration of video data stored in the video store 110 that is done in a novel fashion. It should be noted that for the purpose of this disclosure, a video still is to be called a clip, since it really is the shortest clip that can be obtained. These clips can be for full raster video or may be ‘fenced’ or ‘cropped’ to be a portion of the full raster and may include embedded audio.

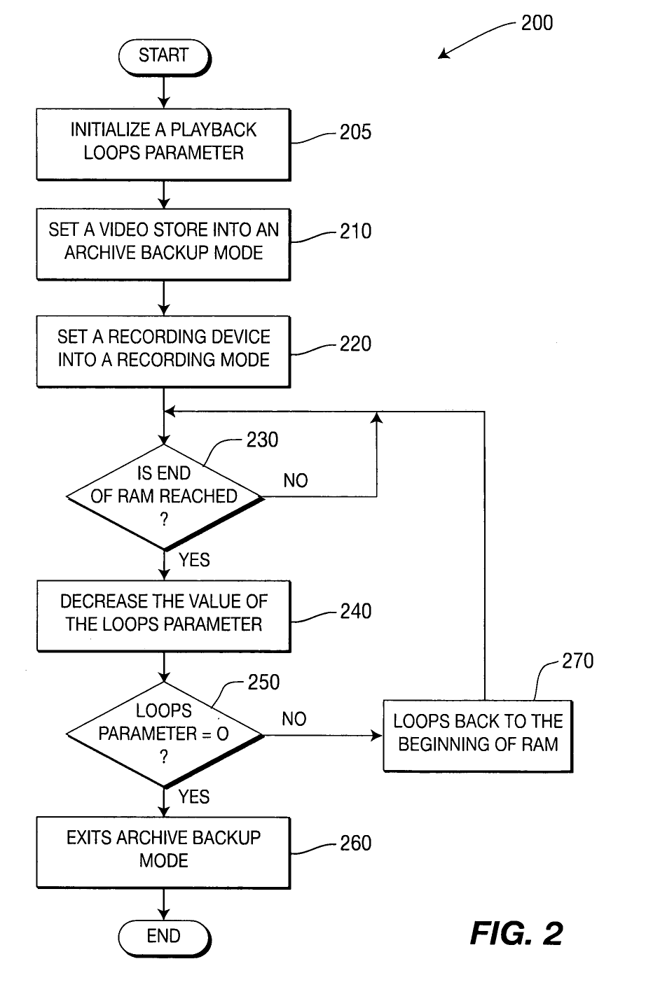

FIG. 2 shows a non-limiting and exemplary flowchart 200 describing the process for archival creation of video clips stored in the video store 110. The process described herein is automated and may be activated according to a predefined policy (e.g., every day, every week, etc.). In another embodiment the process may be activated by a user.

At S205, a parameter representing a number of playback loops is initialized to a predefined value, e.g., three (3) loops. As such, the video contents of the video RAM 102 would be repeatedly played back for the predefined number of times. At S210, once the process for creating a video archive is activated, the video store 110 is set to operate in an archival backup loop mode. In this mode of operation, the video store 110 transfers, by cycling a plurality of times through the video RAM 102, the whole contents of the video RAM 102. The stored video clips are transferred as video and at video rate, to the video recording device 120. The video signal (played video data) is contiguously sent as a series of video frames, irrespective of the directory structure of the video store 110. That is, the video store archiving process as envisioned by the invention completely ignores the associated directory structure for each video clip and/or video frame. At S220, the video recording device 120 is set to operate in a recording mode to record a portion or all of the played video data sent from video store 110, thereby storing all the video clips at least once on the video recording device 120.

During the recording process, the played video data to be recorded may be digitized and the digitized data may be further compressed using conventional compressing algorithms, such as MPEG, before being recorded by the video recording device.

When the video data has been completely played out, the CPU 104 loops back to the beginning of the video RAM 102. This process repeats as the number of times indicated by the playback loops parameter. Specifically, at S230 a check is made to determine if the process has reached to the end of the video RAM 102, i.e., if all the video clips stored in the video RAM 102 were transferred, and if so execution continues with S240; otherwise, execution waits at S230. At S240, the number of playback loops parameter is decreased by a value of one (1), and at S250 it is checked if the parameter's value equals to zero. If so, at S260, the video store 110 is instructed to exit the archival backup loop mode and the recording device 120 stops to record. Thereafter, execution terminates; otherwise, execution continues with S270 where the video data is being played out from the beginning of the video RAM 102. Thereafter, execution returns to S230.

In accordance with one embodiment of the invention, the video RAM 102 includes at least one reserved identification (ID) frame that is used in combination with a known pre-designed and visually or programmatically recognizable video pattern. Generally, the video pattern can be any recognizable graphic test pattern but may also be embodied by the company logo in conjunction with the name of the device over a colored background. The reserved ID frame can be also stored in the CPU-RAM 106 and/or any volatile or non-volatile memory accessible by the CPU 104. As will be described in greater detail below, the reserved ID frame is utilized to resynchronize the directory and/or metadata of the restored video data.

In accordance with an exemplary embodiment the steps of the process 200 described herein can be manually performed by a user. Specifically, the user enters the video store 110 to an archival backup loop mode preferably using the computer 130 and sets the video recording device 120 to start recoding. Then, the user waits for a predetermined number of playback loops to play out from the video store 110. As the video data is played out and transferred, at a video rate, the waiting time of the user may be a function of the duration of the video clips stored in the video RAM 102. However, it should be noted that the length of the playback loops (i.e., the waiting time) as well as the beginning and ending time of the recording are approximate only. Thereafter, a command is received from the user to take the video store 110 out of the archival backup loop mode and the video store 110 is commanded to stop looping the video data.

Note that since the operation of the video store and that of the recording device may not completely in synchronization, only a portion of the received or transmitted video signal is recorded. This is true for both the archiving and restoring processes.

Although illustrated as playing back the whole contents of the video RAM 102, the principles of the invention may be applied to a pre-defined portion of the video RAM 102 but the identifying frame for the predefined portion may be required for resynchronization purposes. The pre-defined portion must be known by the video store 110. This is true for both the archiving and restoring processes.

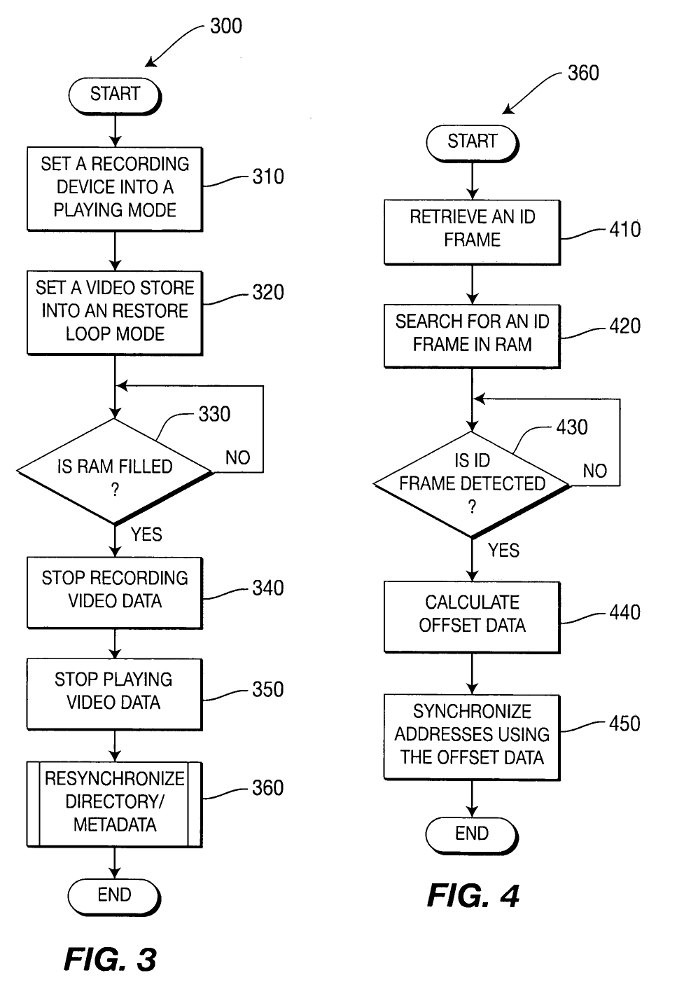

FIG. 3 shows a non-limiting and exemplary flowchart 300 describing the process for restoring of a video store archive implemented in accordance with an embodiment of the invention. The archival restoration process restores the content stored in the video recording device 120 using the process described in greater detail above. The aforementioned video recording device 120 now becomes the source memory for playing of the archive video. Also, the video store 110 which was playing out before in the archival creation process is now the target memory since it is the recorder in the archival restoration process.

At S310 the video recording device 120 is set to play a previously recorded archival video data, which should include more than one instance of the video data previously stored in the video store 110. The played video data is transferred to the video store 110 at a video rate. At S320 the video store 110 is instructed to enter into an archival restore loop mode to record the previously recorded archival video being played out from the video recording device 120. That is, in the restore loop mode of operation the video signal (the played video data) sent from the recording device 120 is recorded on the video RAM 102. At S330, a check is made to determine if the video RAM 102 has been filled, and if so execution continues with S340; otherwise, execution continues at S330. Execution reaches to S340 when the video RAM 102 is filled, thus the video store 110 stops recording the video data. Then, at S350, the video recording device 120 is instructed to stop playing the previously recorded archival video data.

During the recording process, the played video data to be recorded may be digitized and the digitized data may be further compressed using conventional compressing algorithms, such as MPEG, before being recorded in the video RAM 102.

After the RAM 102 has been completely loaded and upon playback of the video recording device 120 there exists one complete copy of the video content originally stored in the RAM 102. But because the metadata and directory structure was not considered during the archival process, the video data is offset by a random amount from where it was originally located in the video RAM 102. To fix the inconsistency of locations, at S360, resynchronization of the video store directory structure and metadata with the newly restored archival backup is preformed.

Referring now to FIG. 4, the operation of S360 is described in greater detail. An important feature of this resynchronization step is that whilst the video data has been offset by a random amount from where it was before, the entire video clip has been offset by the same amount yielding a constant linear offset. Because of the constant nature of the offset it is a simple process to correct the offsets throughout the address references in the directory. With this aim, the resynchronization step determines and corrects an ‘offset delta’ which is the measure of how much the data in the video RAM 102 has shifted from where it was previously. The offset determination is performed using the identification (ID) frame.

At S410, the ID frame and its original start address are retrieved from the CPU-RAM 106. At S420, the CPU 104 searches the video RAM 102 to find a pattern that matches the content of the ID frame by comparing the pattern of the ID frame with all the video data stored in the video RAM 102. As mentioned above, the ID frame is a known pre-designed and visually recognizable video pattern. At S430, a check is made to determine if a match is detected, and if so, execution continues with S440; otherwise, execution returns to S420. In accordance with an exemplary embodiment of the invention, the detection of ID frames in the video RAM 102 can be performed using a dedicated hardware, e.g., a FPGA. At S440, the offset delta is calculated by subtracting a current address (i.e., an address of the detected ID frame in the video RAM 102) by the original address of the frame ID. The offset delta's value can be a positive or negative quantity.

At S450, the video store directory structure is resynchronized using the calculated offset delta. The invention supports the resynchronization of a variety of video store directory structures. In accordance with one embodiment the invention supports a simple directory structure. Such directory contains the address of the first frame in the video RAM 102 and the address of the last frame in the video RAM 102. To fix such a directory structure the offset delta is simply added to these addresses by passing through the directory. It should be noted that when a newly calculated address is greater than the size of the video RAM 102, a wraparound condition has occurred, and the size of the video RAM 102 is subtracted to create the new address.

In accordance with another embodiment, the invention supports complicated directory structures in which the whole clip is not contiguous in the video RAM 102, and the RAM 102 comprise essentially linked lists of pointers to addresses for each frame. The same process of adding the offset delta to these addresses is applied to the linked list of pointers. Other embodiments for synchronizing the directory structure will be apparent to one of ordinary skill in the art.

In one embodiment, instead of recording the offset information, the address information in the metadata can be replaced by the absolute addresses derived from the address of the determined ID frame discussed above.

In accordance with an exemplary embodiment the steps of the process 300 described herein can be manually performed by a user. Specifically, the user enters the video store 110 to a restore loop mode preferably using the computer 130 and sets the video recording device 120 to play out the video data. Then, the user waits until the whole contents of stored in the video recording device 120 is transferred to the video store 110, i.e., until the video RAM 102 is completely filled. As the video is played out and transferred at a video rate, the waiting time of the user may be a function of the duration of the video clips stored in the video recording device 120.

To resynchronize the directory structure of the newly load video data, a command is received from the user using the computer 130 to place the video store 110 into an archival restore jog mode. Subsequently, the ID frame is manually detected by visual inspection by the user. The user manually fast-forwards or jogs the video store 110 until the ID frame is found visually. Once the ID frame is found, the user manually instructs the video store 110 to resynchronize directory/metadata with the recorded archival video newly recorded on the video store. Consequently, the offset delta is calculated and added to the frames' addresses as mentioned above.

It has been repeatedly stated that this invention may be wholly or partially automated depending upon the degree of automation desired. This is accomplished through the use of a software automation controller that may be implemented in a variety of fashions. Some of these implementations include but are not limited to: software stored into a memory (e.g., CPU-RAM 106) whether volatile or non-volatile that is accessible by the CPU 104, one or more pieces of hardware (microcontroller-s) that control both the creation and restoration processes along with associated glue logic.

On another note, the directory and or metadata are encoded into video as pseudo video and backed up and restored as described previously. This works perfectly if the backup video recording device 120 does not compress the video. However, in most practical applications the video recording device 120 does indeed apply a video compression algorithm. Whilst visually acceptable for real video, the results are unpredictable for the directory data encoded as pseudo-video making it impossible to use. So for this invention, it is posited that the directory and metadata are archived using conventional file transfer techniques. The data may be transferred as one archival file that is a package of the material or as individual files. As stated before, the quantity of data is relatively small and the time to transfer these files is small.

In some implementations the video store 110 is volatile, but the directory structure and metadata are maintained on a regular computer style hard drive. So it is only the video data that needs to be backed up on a regular basis. Indeed to ensure a full recovery, a backup should be made each time video is added or removed from the video store.

However, the most general case of this invention is to at periodic intervals make video backups as described in the invention and metadata/directory backup using file transfer mechanisms at the same time. In the event that it is necessary to restore the last backup, the metadata/directory backup is restored first and then the video backup is restored as described.

The invention, as would be known to one of ordinary skill in the art could be produced in hardware or software, or in a combination of hardware and software. The system, or method, according to the inventive principles as disclosed in connection with the preferred embodiment and other embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment and other embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory, or may be on a transportable medium such as a disk, or a fixed disk, or a memory stick, or any other type of memory as known to those of ordinary skill in the art.

The invention is not limited to any particular computer program or logic or language instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, disk drive memory, CD-ROM, and other permanent storage. Additionally, a computer readable medium may include, for example, volatile storage, such as RAM, buffers, cache memory, and network circuits.

Further, the computer readable medium may include computer readable information in a transitory state medium such as a network link and /or a network interface, including a wired network or a wireless network, that allow a computer to read such computer readable medium.

1. A method for recording video data comprising:
receiving video signals representing a first video data responsive to a first command;
recording a portion of the received video signals; and
terminating the recording process responsive to a second command, wherein the recorded video signals represent more than one instance of the first video data.

2. The method of claim 1, wherein the recording step further comprises:
digitizing the portion of the received video signals.

3. The method of claim 2, wherein the recording step further comprises:
encoding the digitized video signals.

4. The method of claim 1, wherein the video signals are generated by repeatedly playing the first video data from a video store a predetermined number of times.

5. The method of claim 4, further comprising the step of receiving the second command after the predetermined number of times has been played.

6. The method of claim 4, wherein the video store plays the first video data at a video rate.

7. The method of claim 1, wherein the first video data includes a frame identifying beginning of the first video data.

8. A computer program product including a computer-readable medium comprising software instructions operable to enable a computer to perform a method for archiving first video data from a video store comprising:
receiving video signals representing the first video data responsive to a first command;
recording a portion of the received video signals; and
terminating the recording process responsive to a second command wherein the recorded video signals represent more than one instance of the first video data.

9. The computer program product of claim 8, wherein the recording step further comprises:
digitizing the portion of the received video signals.

10. The computer program product of claim 9, wherein the recording step further comprises:
encoding the digitized video signals.

11. The computer program product of claim 8, wherein the video signals are generated by repeatedly playing the first video data from the video store a predetermined number of times.

12. The computer program product of claim 11, further comprising the step of receiving the second command after the predetermined number of times has been played.

13. The computer program product of claim 8, wherein the video store plays the first video data at a video rate.

14. The computer program product of claim 8, wherein the first video data includes a frame identifying beginning of the first video data.

15. A method for restoring first video data from a video recoding device storing second video data representing more than one instance of the first video data, comprising:
receiving video signals from the video recoding device playing back the second video data;
recording a portion of the received video signals to a memory responsive to a command; and
terminating the recording process when the memory is filled, wherein the recorded video signals represents at least one instance of the first video data.

16. The method of claim 15, further comprising:
setting a video store into the archival restore loop mode; and
waiting for the memory to be filled.

17. The method of claim 15, wherein the first video data includes a frame identifying beginning of the first video data.

18. The method of claim 17, further comprising:
receiving a command to resynchronize metadata with the recorded video signals, the metadata including address information of the identifying frame in the memory; and
resynchronizing the metadata with the recorded video signals by identifying a frame in the recorded video signals representing the identifying frame of the first video data.

19. The method of claim 18, wherein the step of resynchronizing of the metadata further comprising:
determining an address of the frame representing the identifying (ID) frame; and
correcting the address information in the metadata using the determined address.

20. The method of claim 15, wherein the recording step further comprises:
digitizing the portion of the received video signals;
encoding the digitized video signals; and
recording the encoded video signals.

21. A computer program product including a computer-readable medium comprising software instructions operable to enable a computer to perform a method restoring first video data to a video store from a video recoding device storing a second video data representing more than one instance of the first video data, comprising:
receiving video signals from the video recoding device playing back the second video data;
recording a portion of the received video signals to a memory responsive to a command; and
terminating the recording process when the memory is filled, wherein the recorded video signals represents at least one instance of the first video data.

22. The computer program product of claim 19, further comprising:
setting the video store into the archival restore loop mode; and
waiting for the memory to be filled.

23. The computer program product of claim 20, wherein the first video data includes a frame identifying beginning of the first video data.

24. The computer program product of claim 21, further comprising:
receiving a command to resynchronize metadata with the recorded archival video newly recorded on the video store, the metadata including address information of the identifying frame in the memory; and
resynchronizing the metadata with the recorded video signals by identifying a frame in the recorded video signals representing the identifying frame of the first.

25. The computer program product of claim 24, wherein the step of resynchronizing of the metadata further comprising:
determining an address of the frame representing the identifying (ID) frame; and
correcting the address information in the metadata using the determined address.

26. The computer program product of claim 21, wherein the recording step further comprises:
digitizing the portion of the received video signals;
encoding the digitized video signals; and
recording the encoded video signals.

27. A method for recording video data comprising:
receiving, by a video store, a first command for repeatedly playing back the first video data for a number of times; and
playing back, by the video store, the first video data for the number of times, wherein a portion of the played first video data is recorded by a video recording device and the recorded played first video data represents more than one instance of the first video data.

28. A method for restoring first video data from a video recoding device storing second video data representing more than one instance of the first video data, comprising:
transmitting video signals from the video recoding device playing back the second video data, wherein the video signals are received by a video store and a portion of said received video signals is recorded by the video store in a memory; and
terminating the playing back process responsive to a signal generated when the memory has been filled and the recorded video signals represent at least one instance of the first video data.
